(19) United States
(12) Patent Application Publication
(10) Pub. No.: US 2009/0088956 A1
(43) Pub. Date: Apr. 2, 2009

(54) ROBUST ONBOARD DIAGNOSTIC MISFIRE DETECTION

(75) Inventors: George Lin, Dunlap, IL (US); Drew Wackerlin, Metamora, IL (US)

Correspondence Address: LEYDIG, VOIT & MAYER, LTD, TWO PRUDENTIAL PLAZA SUITE 4900, 180 N. STETSON AVE, CHICAGO, IL, 60601, US

(73) Assignee: CATERPILLAR INC., Peoria, IL (US)

(21) Appl. No.: 11/868,154

(22) Filed: Oct. 5, 2007

Related U.S. Application Data
(63) Continuation-in-part of application No. 11/863,107, filed on Sep. 27, 2007, now abandoned.

(51) Int. Cl. G01M 15/11; G01M 15/00; F02D 45/00; B60Q 11/00

(52) U.S. Cl. 701/111; 701/111; 340/441

(57) ABSTRACT

A misfire detection system and method for onboard diagnosis of engine performance detects an engine speed as a function of a rotational angle of the crankshaft, and determines crankshaft acceleration as a function of this angle based on the detected engine speed. In this manner, the power stroke acceleration of each cylinder is determined and ranked. After excluding the greatest acceleration, the accelerations of a group of consecutively ordered cylinders including the second greatest acceleration are averaged to produce an assessment level against which the remaining lower-ranked cylinders are evaluated to detect misfires.

### CROSS-REFERENCE TO RELATED APPLICATIONS

This patent application is a continuation-in-part of copending U.S. patent application Ser. No. 11/863,107, filed Sep. 27, 2007, the contents of which are hereby incorporated by reference.

### TECHNICAL FIELD

This patent disclosure relates generally to onboard engine diagnostics and, more particularly to a robust system for determining whether a multi-cylinder engine is misfiring on one or more cylinders.

### BACKGROUND

Internal combustion engines are typically driven by a series of combustion events timed to drive one or more pistons within cylinders. Each such combustion event in a cylinder initiates what is often referred to as a “power stroke” for that cylinder. In 4-cycle engines, there are two crankshaft revolutions (4 one-way strokes) for each power stroke. Most engines in use today for transportation and industry are of a 4-stroke design, although 2-stroke engines are still employed for smaller engines where emission regulations are more lax. Although the disclosed technology offers the greatest benefit in 4-stroke engines, 2-stroke engines may also benefit from these principles.

During the power stroke, the reciprocating motion of the pistons is converted to useful rotary motion via a crankshaft. After the power stroke, the momentum of the crankshaft and flywheel, as well as the power strokes of other cylinders, drive the piston through an exhaust cycle and back into position for another power stroke.

In the present document, a “misfire” is an absence of a combustion event during a power stroke of a cylinder. Generally, a multi-cylinder engine will still run when a small percentage of cylinders are continually misfiring. However, the engine will not develop full power under such circumstances due to the absent power strokes. In addition, the presence of continual misfires will reduce engine efficiency, increase harmful engine emissions, and may damage exhaust treatment components. The reduction in engine efficiency is the result of nonfunctioning cylinders imposing drag on the other cylinders, as well as the ejection of raw fuel into the exhaust stream. The thermal cycling induced by the presence of raw fuel in the exhaust may also degrade catalytic converter components, further exacerbating the emissions problems caused by the misfires.

Thus, it is desirable to detect cylinder misfires so that appropriate repairs or adjustments may be undertaken. However, it has traditionally been difficult to reliably detect misfires. One attempt to identify misfiring cylinders is illustrated in U.S. Pat. No. 5,044,195 to James et al., entitled “Misfire Detection in an Internal Combustion Engine.” The James patent describes an apparatus for detecting misfires occurring during operation of a multi-cylinder internal combustion engine. The system measures the engine acceleration corresponding to each cylinder firing and determines an average acceleration over a series of the cylinder firings centered around a selected cylinder. The deviation of acceleration of the selected cylinder firing from the average acceleration and of the engine torque during each cylinder firing are used to determine a misfire, the idea being that a significant deviation in torque and acceleration indicate a misfire.

However, the present inventors have discovered that such techniques, while functioning satisfactorily to detect single-cylinder misfires, do not reliably identify misfires when multiple cylinders are misfiring. At the same time, such systems are much more likely to signal false positives, i.e., to signal a misfire when none is present. Although some implementations of the examples disclosed herein will operate to solve this problem, it will be appreciated that resolving the shortcomings of James is not a limitation or essential feature of the present innovation.

This background discussion is presented for the reader's convenience, and is not intended to identify relevant prior art or to conclusively characterize any art. The teachings of James will be best understood by reference to James itself, and the foregoing discussion is not intended to extend the teachings of James in any way. Any inconsistency in this characterization should be resolved in favor of the James disclosure, not this background section.

### BRIEF SUMMARY OF THE INVENTION

The disclosed principles pertain to a method for onboard diagnosis of engine performance for a multi-cylinder internal combustion engine. The onboard diagnosis process determines whether one or more cylinders of the engine are misfiring by detecting the engine speed as a function of the rotational angle of the crankshaft and determining crankshaft acceleration as a function of the power stroke of each cylinder. After ordering the cylinders in order of their respective accelerations, the process averages the accelerations of a group of consecutively ordered cylinders, including the second greatest acceleration and excluding the greatest acceleration and determines a deviation of the remaining cylinders from the average acceleration. Based on the determined deviation of the remaining cylinders, the process determines whether one or more of the remaining cylinders are misfiring.

### BRIEF DESCRIPTION OF THE DRAWINGS

FIG. 1 is a schematic side-view of the pistons and crankshaft assembly for a multi-cylinder internal combustion engine within which the described examples may be implemented;

FIG. 2 is a simplified view of a speed wheel with indications for cylinder firing order thereon;

FIG. 3 is an idealized crankshaft speed plot showing crankshaft RPM as a function of crankshaft angle;

FIG. 4 is an simulated functional crankshaft speed plot showing crankshaft RPM as a function of crankshaft angle;

FIG. 5 is a cylinder acceleration plot showing cylinder power stroke accelerations in firing order;

FIG. 6 is a cylinder acceleration plot showing cylinder power stroke accelerations in ascending order of acceleration;

FIG. 7 is a cylinder acceleration plot showing cylinder power stroke accelerations in ascending order of acceleration, wherein the cylinder having the highest acceleration has been excluded and the next three highest cylinders have been averaged;

FIG. 8 is a flow chart of an exemplary process of onboard misfire analysis in keeping with the described principles; and

FIG. 9 is a schematic view of an engine and controller for implementing diagnostic functions according to the described principles.

### DETAILED DESCRIPTION

This disclosure relates to an on board diagnostic system for detecting cylinder misfires in a multi-cylinder engine. As noted above, cylinder misfires cause fuel inefficiency and harmful emissions. In the case of heavy-duty industrial engines, these problems can have significant cost and regulatory impacts. Indeed, it appears that as of 2010, engines will be required by the United States Environmental Protection Agency and California Air Resources Board to have an onboard diagnostics system capable of detecting a cylinder that continually misfires (i.e., with no intervening partial or full combustion power strokes during the test period). These regulations will require that the onboard diagnostics system detect a cylinder that continuously misfires during engine idle. For purposes of those regulations, the term “idle” denotes a situation wherein the accelerator pedal or other throttle actuator is released and the machine speed and load are less than respective predefined small percentages (e.g., 1% and 2% respectively). The misfire detection should begin within two revolutions of engine start, i.e., the time that the engine speed is within 150 RPM of the engine idle speed, and should not take longer than 15 seconds of idle time or 1000 revolutions to complete. While the described system will meet these requirements in many implementations, it is not required that all implementations meet these limitations. Moreover, while the operations of some implementations may meet or exceed the foregoing requirements, some implementations will fall short of these requirements since the disclosed principles and techniques are also applicable to operating environments other than those contemplated by the EPA or CARB rules of interest

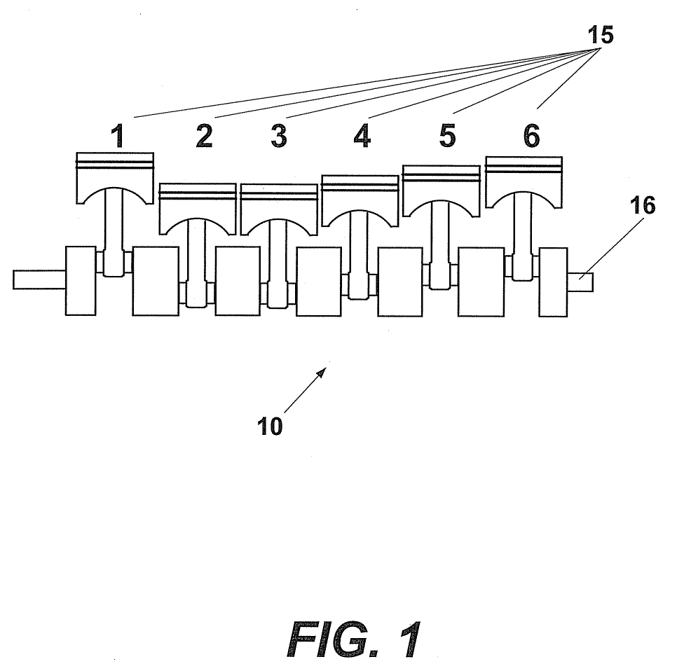

In order to understand the disclosed system, it is useful to understand the way in which cylinders are typically designated. Most present day multi-cylinder engines are “in-line” engines, meaning that the cylinder bores are perpendicular to the engine shaft axis and are arranged in a row or “line” along the axis. The cylinders are numbered conceptually in order along the axis. Thus, as shown in the engine diagram 10 of FIG. 1, in the example of a 6-cylinder 4-stroke engine, the cylinders (represented by pistons 15) are number 1 through 6 along the crankshaft 16. Nonetheless, the cylinders 15 typically do not fire in numerical order. Rather, the firing order is generally set so as to optimize engine smoothness. Thus, although firings are evenly spaced by design, consecutive cylinders 15 typically do not fire consecutively.

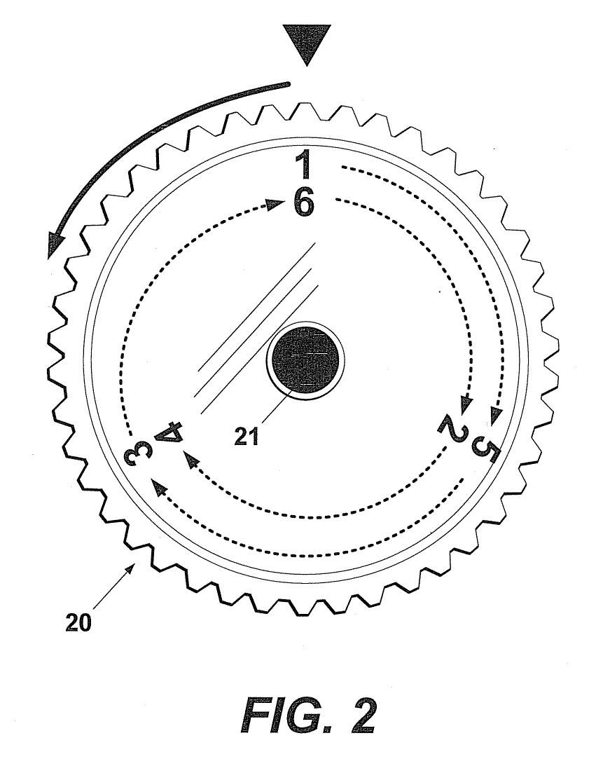

The speed wheel 20 of FIG. 2 illustrates a possible firing order in the 6-cylinder 4-stroke engine of FIG. 1. As the engine shaft 21 rotates, a cylinder fires every 120 degrees, such that after 2 revolutions (720 degrees) all cylinders have fired. Recall that in a four-stroke engine each cylinder supplies a power stroke only once every other revolution. In the illustrated example, the firing order is 1-5-3-6-2-4. Other firing orders are possible as well. Examples of various popular firing orders for engines of different numbers of cylinders include 1-3-2 (three cylinders), 1-3-4-2 (four cylinders), 1-2-4-5-3 (five cylinders), 1-5-3-6-2-4 (six cylinders), 1-6-5-4-3-2 (six cylinders), 1-8-7-2-6-5-4-3 (eight cylinders), 1-10-9-4-3-6-5-8-7-2 (ten cylinders), 1-7-5-11-3-9-6-12-2-8-4-10 (twelve cylinders), and 1-12-8-11-7-14-5-16-4-15-3-10-6-9-2-13 (sixteen cylinders).

The speed wheel 20 can be used to track crankshaft speed with relatively high resolution, e.g., approximately every 5 degrees. From the detected speed, the instantaneous crankshaft acceleration can be calculated. Those of skill in the art will be familiar with the design and operation of speed wheels, so that no further explanation is necessary at this point.

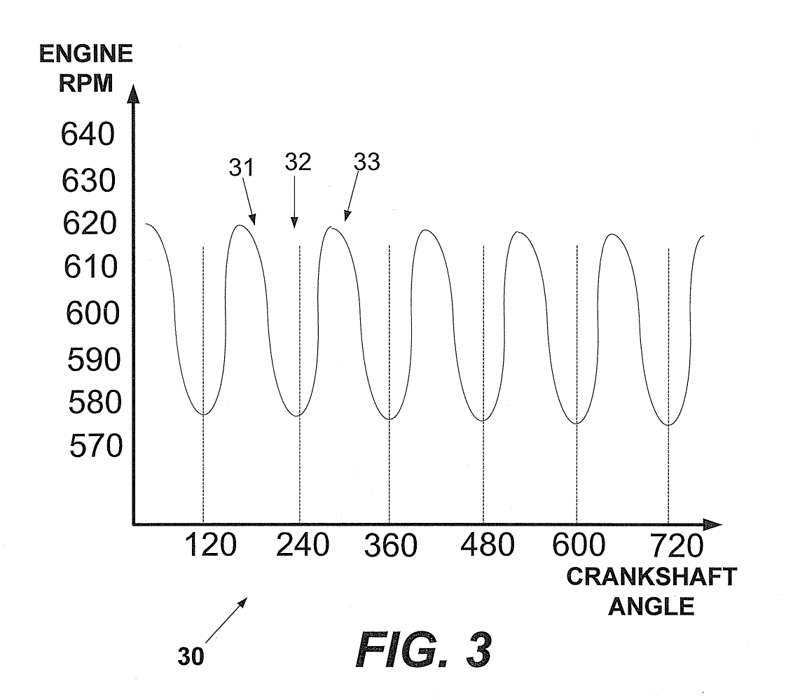

Prior to each power stroke, there is a compression event in the cylinder of interest. Thus, the crankshaft slows slightly before combustion under the resistance of the compression stroke, and accelerates slightly during combustion. The timing plot of FIG. 3 illustrates an idealized speed plot 30 of the crankshaft speed as a function of shaft angle during operation. It can be seen that from point 31 prior to the start of the combustion period at 32, the crankshaft decelerates. After the combustion begins at 32, the crankshaft accelerates until the compression stroke of the next firing cylinder begins at 33. In the idealized plot 30, the average engine RPM does not fluctuate on the time scale shown, nor are any cylinders misfiring.

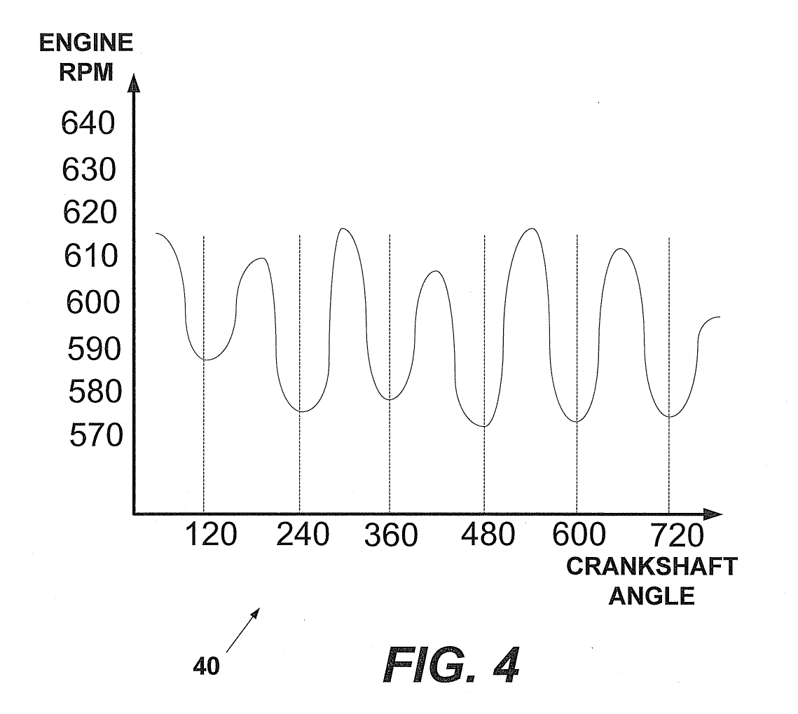

In reality, as shown in the timing plot 40 of FIG. 4, the average engine speed typically fluctuates and the accelerations and decelerations due to combustion and compression will not be identical from one cylinder to the next, even in the absence of misfires. In addition, a misfiring cylinder may still exhibit a deceleration caused by compression (although it may be less than normal if the injection is not occurring normally), and an acceleration event due at least to cylinder decompression after reaching top dead center. Given the fluctuations in operating cylinders and the presence of decelerations and accelerations associated with misfiring cylinders, it can be difficult to conclusively identify any misfiring cylinder or cylinders.

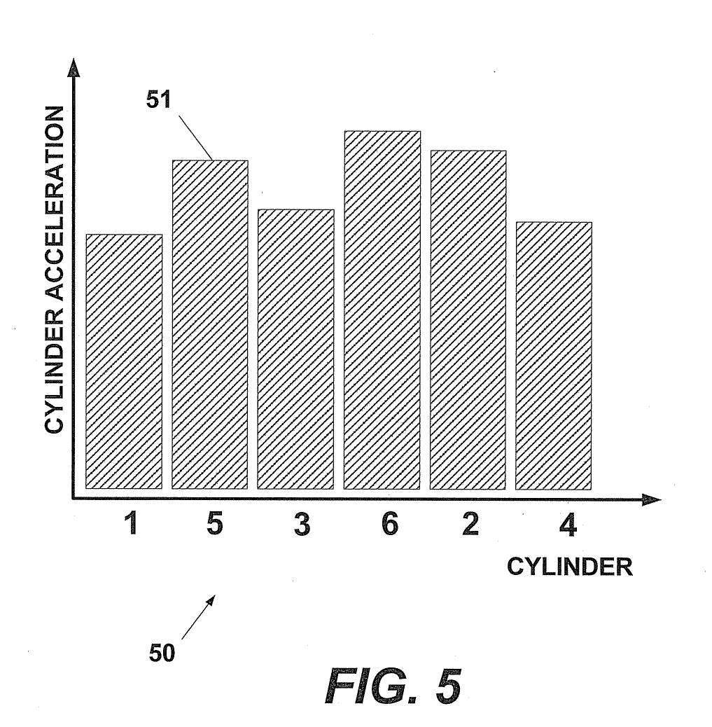

In overview, in order to detect cylinders providing an abnormally low amount of rotational energy, and thus identify misfiring cylinders, the power stroke acceleration of the crankshaft is first quantified as shown in the plot 50 of FIG. 5. The height of each plot bar 51 represents the power stroke acceleration of the associated cylinder. It will be appreciated that the acceleration may be quantified in any convenient units or may be normalized, so long as the relative proportions of the accelerations are maintained.

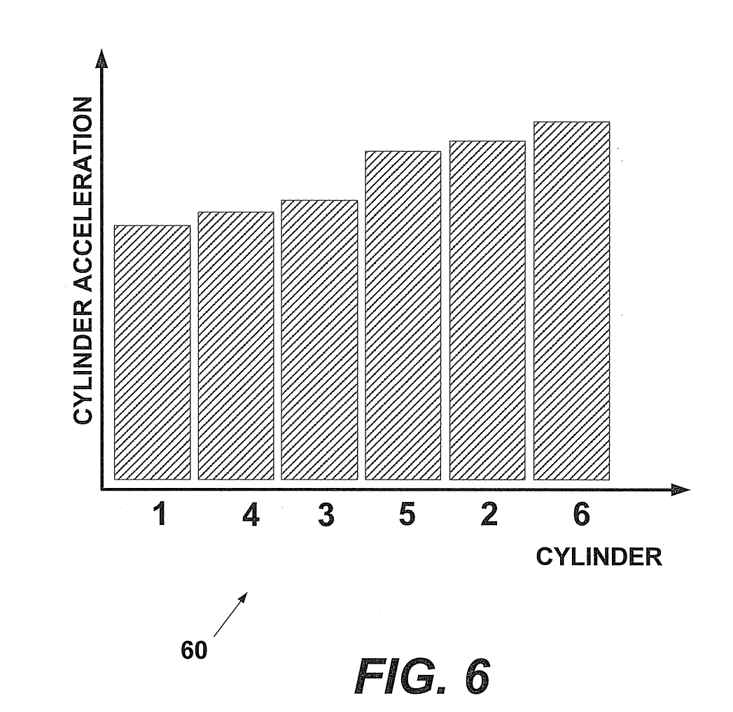

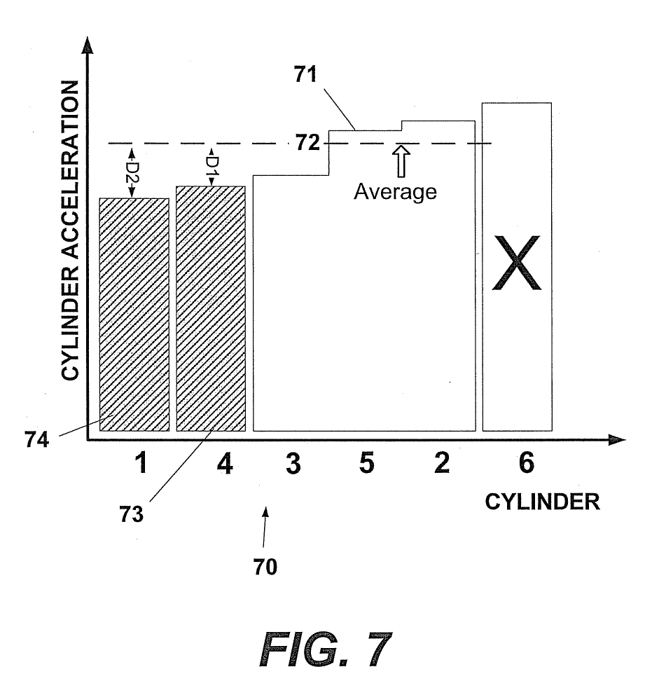

The cylinders are then ranked in order of acceleration as shown in the plot 60 of FIG. 6. As shown in FIG. 7, the cylinder with the highest acceleration is dropped from the calculation. Of the remaining cylinders, a group 71 of cylinders having the highest consecutive acceleration rankings (the standard set) are averaged to create an assessment level 72 against which to judge the remaining cylinders 73, 74. Finally, the remaining cylinders 73, 74 are compared to this assessment level 72 to determine whether or not they are misfiring. In a further embodiment, the lowest cylinder in the standard set 71 may be moved from the standard set to the remaining cylinders to be evaluated if it deviates more from the standard set 72 than from the remaining cylinders. In this way, the system is able to accurately detect a greater number of misfires, e.g., up to three misfires on a 6-cylinder engine.

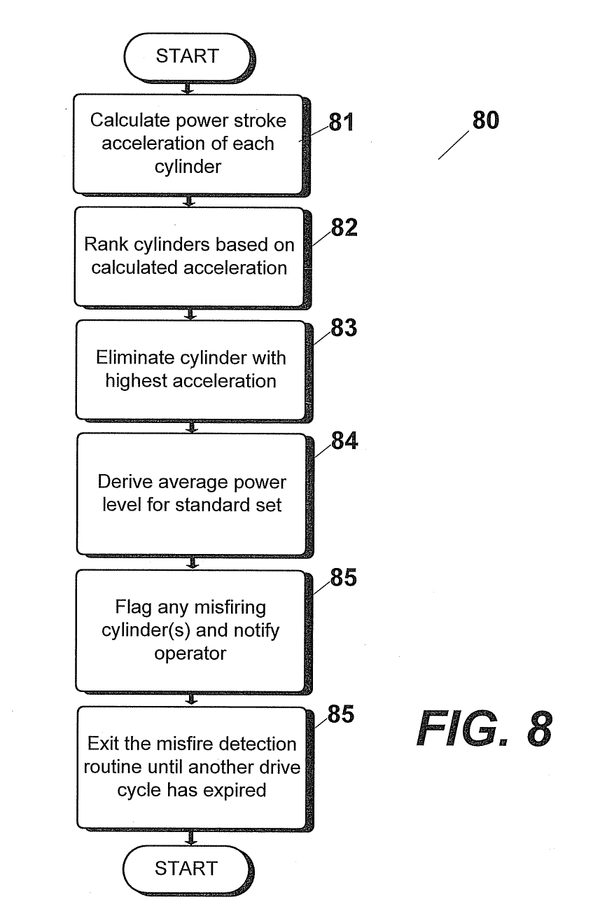

Given the foregoing overview, the details of exemplary implementations of the disclosed misfire detection system will be discussed with reference to the flow chart of FIG. 8. It will be appreciated that the values calculated in process 80, e.g., averages, accelerations, etc., may be calculated instantaneously or may be averaged on an interval or continuous basis. At stage 81 of the onboard diagnostic process 80, the diagnostic system calculates the power stroke acceleration of each cylinder. This calculation is based on (1) the position of the speed wheel (to determine TDC and BDC) and (2) the acceleration of the speed wheel (e.g., the time elapsed between TDC and BDC) during the power stroke. The cylinders are then ranked sequentially in stage 82 based on the calculated acceleration. Alternatively, the diagnostic process 80 can execute as frequently as each combustion event, combined with data from the last set of combustion events. Repeating the diagnostic process for each combustion event allows the strategy to be more robust to moderate changes in engine operation, but requires more processor 94 resources.

At stage 83, the set of accelerations is reduced by eliminating the cylinder having the highest power stroke acceleration. This reduces the probability of false positives by acknowledging that very often one cylinder will be “hotter” or more powerful than the others. By eliminating this cylinder from the remaining diagnostic calculations, the cylinders under evaluation (e.g., the weakest cylinders) will be measured against a more typical power stroke acceleration standard. The highest three cylinders (the standard set) in the remaining set are averaged at stage 84 to derive an average power level, or assessment level, against which to judge the remaining cylinders, and a deviation or pseudo deviation value is calculated based on the standard set. The pseudo deviation value is chosen to reflect how far apart the cylinder accelerations are expected to be during proper operation, in view of the actuality that different engines have different such deviations. Alternatively, a deviation may be measured based solely on the calculated accelerations in the cylinders of the standard set.

At stage 85, the diagnostic system calculates the distance between the accelerations of the cylinders under evaluation and the average acceleration previously calculated in stage 84. In FIG. 6, these distances are shown as D1 and D2. Based at least on this distance, one or more of the cylinders under evaluation may be flagged as misfiring at stage 86.

Although any suitable technique may be used to evaluate and characterize the effect of the distance between a cylinder under analysis and the average acceleration calculated in stage 84, in an embodiment the diagnostic system determines based on the distance and other factors whether a trip threshold is triggered as well as a probability of misfire (0-100%).

According to this embodiment, the trip threshold is calculated as x_{fail}=((kₓ· x̅)−(k_{σ}·σ)^{k}^{ₑ}) where x_{fail} is the threshold for declaring a misfire, kₓ and k_{σ} are gain constants for scaling the mean and pseudo deviation, kₑ is an exponent used to scale the input variables, and x̅ and σ are the average and pseudo deviation calculated in stage 84. The misfire probability is calculated as

$${p}_{c} = 1 - ( {k}_{p} \cdot \frac{{x}_{c} - {x}_{fail}}{\overline{x} - {x}_{fail}} ) ,$$

where kₚ is gain constant so that the returned value PC is within 0-100% and xC is the change in engine speed for each power stroke for the cylinder.

If at stage 86 one or more cylinders are flagged as misfiring, then the diagnostic system triggers a warning light to alert the operator regarding the misfiring cylinder(s). Finally, at stage 87, the diagnostic system exits the misfire detection routine until another drive cycle has expired or until such other time as a misfire diagnostic is desired or required.

It will be appreciated that during the misfire analysis, the diagnostic system may store the collected data for later review by a technician or other service personnel. In this manner, trends in cylinder performance may be observed even when they do not immediately result in a misfire diagnosis.

In an alternative embodiment as briefly noted above, the lowest cylinder in the standard set 71 may be moved from the standard set to the remaining cylinders to be evaluated if it deviates more from the standard set 72 than from the remaining cylinders. In particular, in this embodiment, if the acceleration exhibited by the lowest cylinder in the putative standard set has an acceleration that is nearer to the average of the accelerations of the cylinders under analysis than to the average of the other cylinders in the standard set, then the cylinder of interest is included in the cylinders under analysis rather than the standard set. Otherwise, the cylinder of interest in included in the standard set. Thus, if the lowest cylinder in the putative standard set is misfiring, this can be detected. Without this technique, there is a possibility that a misfiring cylinder in the standard set will reduce the average acceleration in that set to the point that misfires in the weakest two cylinders of the engine will go undetected.

It has been observed that even during normal operation, certain cylinders will contribute more to crankshaft acceleration than other cylinders. In an embodiment, prior to stage 82, the diagnostic system applies individual cylinder gains to account for known variations under normal circumstances, such that any resultant abnormal readings can accurately be attributed to abnormal operation.

Although the diagnostic system described thus far is nonintrusive, e.g., the operator is not aware that the system is functioning, it is possible to improve the robustness of the diagnostic by adding one or more intrusive verifier steps. Thus, in a further embodiment, if a cylinder is flagged as misfiring, the diagnostic system cuts the fuel delivery to that cylinder momentarily to observe the affect on crankshaft acceleration. If the power stroke acceleration for that cylinder significantly decreases when fuel is withheld, then the misfire flag is removed. On the other hand, if the power stroke acceleration for that cylinder remains the same when fuel is withheld, then, the cylinder is confirmed as misfiring. Furthermore, misfiring cylinders can then be flagged by the controller 91 to have the fuel delivery disabled (turned off) to protect other engine or machine components such as emissions aftertreatment devices.

Alternatively, to minimize the degree of disruption imposed on the engine operation, the fuel delivery to the potentially misfiring cylinder may be incrementally decreased while the crankshaft response is observed. In particular, in this embodiment, after a cylinder is flagged as potentially misfiring, the diagnostic system confirms or refutes this diagnosis by slowly decreasing the fuel delivery in incremental steps until a statistically significant variation in the crankshaft acceleration and/or deceleration for that cylinder is observed. The fuel delivery may be finely or coarsely incremented, but in an embodiment, the fuel delivery is incremented in steps of about 5%.

If at some fuel delivery level, a statistically significant variation in the crankshaft acceleration and/or deceleration for that cylinder is observed, the cylinder is flagged as not misfiring and the fuel delivery is returned to a normal level. If instead, the fuel delivery reaches a predetermined lower limit, such as zero fuel delivery, with no statistically significant variation occurring, then the cylinder is confirmed as misfiring. In this case, the fuel delivery may be reduced to zero to avoid continued fuel waste, emissions problems, and the deterioration of sensitive exhaust system components.

Although the immediately foregoing embodiment pertains to evaluating the crankshaft acceleration and/or deceleration for the potentially misfiring cylinder, the diagnostic system may additionally or alternatively evaluate the crankshaft acceleration associated with one or more other cylinders. In particular, if the decreasing fuel flow to the flagged cylinder causes a loss of power from that cylinder, the power from the other cylinders of the engine may automatically increase, e.g., via the ECU, to maintain engine speed. This will be reflected as an increase in the acceleration of the crankshaft during the power strokes of the other cylinders.

In a further embodiment, other confirmation steps are additionally or alternatively employed to determine whether a flagged cylinder is actually misfiring. With respect to certain engine configurations and environments, periodic engine loads may disproportionately affect one cylinder or a subset of the cylinders. For example, a periodic engine load that occurs at the same frequency as the combustion cycle at a certain RPM will decrease the acceleration detected from the cylinders firing during the load at that RPM. An example of this phenomenon is a pump load that loads the engine in a periodic manner. In this case, it may appear that the loaded cylinder is misfiring.

Thus, in this embodiment, once a cylinder is flagged as misfiring at a current RPM, the diagnostic system alters the speed of the engine, and thus the combustion cycle frequency. The degree of alteration depends upon the engine speed and configuration, but may be approximately 1% of current RPM by way of example. In this way, the disruptive effect of the alteration is not apparent to the user, but is enough to separate the frequencies of the combustion cycle and any periodic loads. If re-diagnosis of the flagged cylinder at the altered engine speed results in a decision that the cylinder is not misfiring, then the cylinder is confirmed as not misfiring. Otherwise, the cylinder continues to be flagged as misfiring, since the cause of the lack of cylinder power is not attributable to coincidental periodic loading.

### INDUSTRIAL APPLICABILITY

The industrial applicability of the misfire detection system described herein will be readily appreciated from the foregoing discussion. In particular, the disclosed system is applicable to any system incorporating a multi-cylinder internal combustion engine. Such systems include industrial machines, construction machines, and other fuel-driven equipment, whether used for transportation or other operations. In addition to the benefits provided by this system in terms of better engine performance, fuel efficiency, and emissions levels, the system may also assist in meeting governmental guidelines for onboard diagnostics systems. For example, EPA and CARB regulations coming into effect in 2010 will require onboard diagnostics that are capable of meeting certain requirements, and the disclosed principles can be used to meet these requirements.

Since the disclosed system operates by way of sensors that are already in place in many machines, there is little additional cost imposed by the system. Moreover, because measurements are relative, there are no calibration problems in moving the system between chassis. The use of direct crankshaft measurements eliminates problems due to external noise.

Although the signal to noise ratio for crankshaft acceleration measurements is typically not high, the techniques described herein allow the accurate gathering and interpretation of data nonetheless. Finally, in most embodiments, the disclosed system is non-intrusive from the operator's viewpoint. Even in the enhanced accuracy embodiment wherein fuel supply to a cylinder in question in interrupted, the intrusive effect is minimal and temporary.

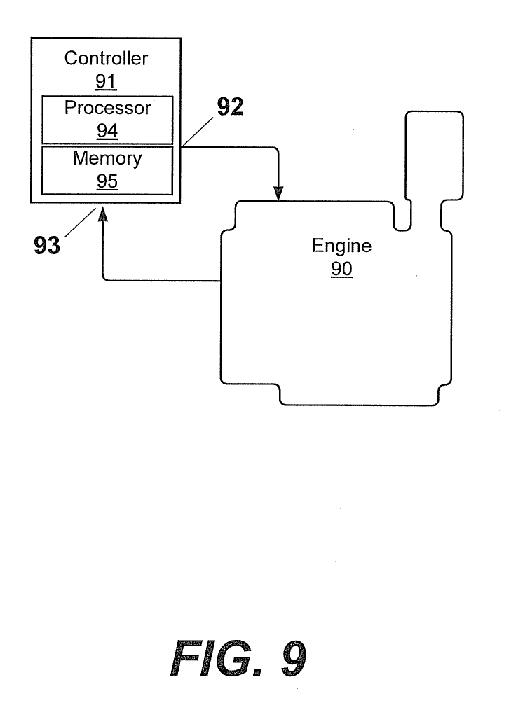

Although the onboard diagnostics system described herein may be executed within any of the machine electronic systems having the necessary computational capabilities, in an embodiment, the onboard diagnostics are executed by an engine controller 91 as shown in FIG. 9. The engine controller 91 includes a processor 94 for reading and executing computer-readable instructions as will be appreciated by those of skill in the art, as well as an input 93, such as an existing data input, for receiving an indication of a rotational speed of the engine 90 over an analysis period during engine idle. This indication may originate directly or indirectly from a speed wheel sensor such as that illustrated above.

In addition, the engine controller 91 includes a memory 95, e.g., RAM, ROM, or flash memory, including volatile and nonvolatile memories, readable by the processor 94. The memory 95 stores computer-executable instructions for determining the power stroke acceleration of each engine cylinder based on the speed of the engine 90 and for ranking the cylinders in order of acceleration as discussed above. The memory 95 further includes instructions for excluding the highest ranked cylinder and averaging the accelerations of the next highest consecutive group of cylinders and comparing any remaining cylinder accelerations to the average to determine whether one or more cylinders of the engine 90 are misfiring.

It will be appreciated that the engine controller 91 is also operable to execute the other diagnosis functions and activities described herein. An output 92 is provided for performing control instructions such as those traditionally executed by an engine controller, as well for executing any control functions entailed in the diagnosis process, e.g., fuel shut-off.

In keeping with the disclosed principles, the diagnostic system may command a fuel interruption prior to the detection of misfires to determine the inertia of the system in order to more accurately set the misfire thresholds. In particular, by adding, subtracting, or multiplying the amount of fuel to a cylinder, the system can determine the rotational inertia of the system. The fuel base (current fuel draw) determines the overall load on the engine, but does not identify the rotational inertia of the system, since no torque is needed to overcome rotational inertia in such circumstances. However, causing a change in the fuel and tracking the engine reaction dynamically, e.g., by observing and quantifying a rise or fall in engine RPM, can be used to determine the approximate rotational inertia of the system.

In an embodiment, the system executes a comparison of (1) engine behavior with the addition of fuel and (2) engine behavior with the subtraction of fuel, to (3) the base operating RPM levels. The well-known force equation F=ma is applicable to linear forces and accelerations. The counterpart relationship for rotational force, or Torque, is T=Ia, where a is the rotational acceleration and I is the object inertia.

This relationship can be used to empirically identify the inertia of the crankshaft and any components linked thereto, and to thus identify the acceleration change to be expected when a cylinder is or is not contributing to the system acceleration. In one embodiment, the system accelerations under fully operation conditions when fuel changes are introduced are defined as a_{increased}_{_{—}}_{flow}=fn[((fuel+Δfuel)−k*load)/(rotational inertia)] and a_{decreased}_{_{—}}_{flow}=fn[((fuel−Δfuel)−k*load)/(rotational inertia)]. The parameter k is a scaling factor such that under steady state conditions, e.g., when engine RPM is constant,fuel=k*load. From the foregoing relationships, it will be appreciated that (a_{increased}_{_{—}}_{flow}−a_{decreased}_{_{—}}_{flow})==fn[2*Δfuel/(Rotational Inertia)], and thus Rotational Inertia=fn[(2*Δfuel)/(a_{increased}_{_{—}}_{flow}−a_{decreased}_{_{—}}_{flow})].

Having defined the rotational inertia based on the fuel reduction and supplementation results, this value is used to set the misfire thresholds. For example, for systems with very high rotational inertia, a misfire event will generate a lower perturbation on the system acceleration. In such circumstances, a low threshold should be selected. Similarly, in a system with low rotational inertia, higher acceleration perturbations are to be expected, and the threshold should be set at a higher value to avoid false positives.

It will be appreciated that the foregoing description provides examples of the disclosed system and technique. However, it is contemplated that other implementations of the disclosure may differ in detail from the foregoing examples. All references to the invention or examples thereof are intended to reference the particular example being discussed at that point and are not intended to imply any limitation as to the scope of the invention more generally. All language of distinction and disparagement with respect to certain features is intended to indicate a lack of preference for those features, but not to exclude such from the scope of the invention entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

We claim:

1. A method for onboard diagnosis of engine performance for a multi-cylinder internal combustion engine to determine whether one or more cylinders of the engine are misfiring, the engine having a crankshaft rotated by combustion events occurring in the cylinders of the engine, the combustion events initiating power strokes, the method comprising:
detecting an engine speed as a function of a rotational angle of the crankshaft;
determining from the detected engine speed, a crankshaft acceleration as a function of the rotational angle of the crankshaft and associating an acceleration with the power stroke of each cylinder;
ordering the cylinders in order of their respective accelerations;
averaging the accelerations of a group of consecutively ordered cylinders, including the second greatest acceleration and excluding the greatest acceleration;
determining respective deviations of the remaining cylinders except the highest ordered cylinder from the average acceleration; and
based on the determined respective deviations of the remaining cylinders, determining whether one or more of the remaining cylinders is misfiring.

2. The method according to claim 1, wherein the engine is a 6-cylinder engine, and wherein averaging the accelerations of a group of consecutively ordered cylinders, including the second greatest acceleration and excluding the greatest acceleration comprises:
averaging the second, third and fourth ranked cylinders to produce an assessment value; and
comparing the accelerations of the fifth and sixth ranked cylinders to the assessment value.

3. The method according to claim 2, wherein determining whether one or more of the remaining cylinders is misfiring based on the respective deviations of the remaining cylinders comprises determining whether any of the respective deviations exceed a threshold value, the threshold value being a function of a rotational inertia of the engine.

4. The method according to claim 2, further comprising notifying an operator of the machine if either of the fifth and sixth ranked cylinders is misfiring by triggering a light within an operator area of the machine.

5. The method according to claim 1, wherein detecting the engine speed as a function of the rotational angle of the crankshaft comprises detecting the engine speed during engine idle.

6. The method according to claim 1, further comprising multiplying each cylinder acceleration by a cylinder gain value prior to ordering the cylinders in order of their respective accelerations.

7. The method according to claim 2, wherein averaging the accelerations of a group of consecutively ordered cylinders further comprises:
analyzing a cylinder acceleration of a lowest ranked cylinder in the group to determine whether it is closer to an average of the rest of the group or is closer to an average of the remaining cylinders not in the group, excluding the greatest acceleration of all cylinders; and
excluding the lowest ranked cylinder in the group from the step of averaging the accelerations of the group, if the cylinder acceleration of the lowest ranked cylinder in the group is closer to the average of the remaining cylinders not in the group, excluding the greatest acceleration of all cylinders.

8. The method according to claim 7, further comprising comparing the acceleration of the lowest ranked cylinder in the group to the assessment value to determine if the lowest ranked cylinder in the group is misfiring.

9. The method according to claim 1, further comprising determining that at least one of the fifth and sixth ranked cylinders is misfiring and disabling fuel delivery to the at least one misfiring cylinder.

10. An engine-driven machine having an onboard diagnosis system for determining whether the engine is operating properly, the machine comprising:
a multi-cylinder internal combustion engine including a crankshaft rotated by combustion events occurring in cylinders of the engine;
a speed sensor for sensing a speed of the crankshaft; and
an onboard diagnostic system adapted to determine the power stroke acceleration of each engine cylinder based on the speed of the crankshaft and rank the cylinders in order of acceleration, and, excluding the highest ranked cylinder, average the accelerations of a next highest consecutive group of cylinders and compare any remaining cylinder accelerations to the average to determine whether one or more cylinders of the engine are misfiring.

11. The machine according to claim 10, wherein the engine is a 6-cylinder engine, and wherein with respect to averaging the accelerations of a group of consecutively ordered cylinders, including the second greatest acceleration and excluding the greatest acceleration, the onboard diagnostic system is further adapted to average the second, third and fourth ranked cylinders to produce an assessment value and compare the accelerations of the fifth and sixth ranked cylinders to the assessment value to determine if either of the fifth and sixth ranked cylinders is misfiring.

12. The machine according to claim 11, wherein the onboard diagnostic system is further adapted to notify an operator of the machine if either of the fifth and sixth ranked cylinders is misfiring by triggering a light within an operator area of the machine.

13. The machine according to claim 10, wherein with respect to detecting the engine speed as a function of the rotational angle of the crankshaft, the onboard diagnostic system is further adapted to detect the engine speed during engine idle.

14. The machine according to claim 11, wherein with respect to averaging the accelerations of a group of consecutively ordered cylinders, the onboard diagnostic system is further adapted to analyze a cylinder acceleration of a lowest ranked cylinder in the group to determine whether it is closer to an average of the rest of the group or is closer to an average of the remaining cylinders not in the group, excluding the greatest acceleration of all cylinders, and to exclude the lowest ranked cylinder in the group from the step of averaging the accelerations of the group, if the cylinder acceleration of the lowest ranked cylinder in the group is closer to the average of the remaining cylinders not in the group, excluding the greatest acceleration of all cylinders.

15. The machine according to claim 10, wherein the onboard diagnostic system is further adapted to compare the acceleration of the lowest ranked cylinder in the group to the assessment value to determine if the lowest ranked cylinder in the group is misfiring.

16. The machine according to claim 10, wherein the onboard diagnostic system is further adapted to restrict fuel flow to any misfiring cylinder to verify that the cylinder is misfiring.

17. The machine according to claim 10, wherein the onboard diagnostic system is further adapted to alter the frequency of combustion events occurring in the engine to verify that a cylinder is misfiring.

18. An engine controller for detecting whether a multi-cylinder engine is continuously misfiring during engine idle, the engine controller comprising:
a processor for reading and executing computer-readable instructions;
an input for receiving an indication of a rotational speed of the engine over an analysis period during engine idle;
a memory readable by the processor and storing computer-executable instructions for determining the power stroke acceleration of each engine cylinder based on the speed of the engine and ranking the cylinders in order of acceleration, and, excluding the highest ranked cylinder, averaging the accelerations of a next highest consecutive group of cylinders and comparing any remaining cylinder accelerations to the average to determine whether one or more cylinders of the engine are misfiring.

19. The engine controller according to claim 18, wherein the engine is a 6-cylinder engine, and wherein with respect to averaging the accelerations of a group of consecutively ordered cylinders, including the second greatest acceleration and excluding the greatest acceleration, the computer-executable instructions include instructions for the processor to average the second, third and fourth ranked cylinders to produce an assessment value and compare the accelerations of the fifth and sixth ranked cylinders to the assessment value to determine if either of the fifth and sixth ranked cylinders is misfiring.

20. The engine controller according to claim 18, wherein the computer-executable instructions include instructions for the processor to multiply each cylinder acceleration by a cylinder gain value prior to ordering the cylinders in order of their respective accelerations.

21. The engine controller according to claim 16, wherein the computer-executable instructions include instructions for the processor to restrict fuel flow to any misfiring cylinder to verify that the cylinder is misfiring.
